(19) United States
(12) Patent Application Publication
(10) Pub. No.: US 2024/0070708 A1
(43) Pub. Date: Feb. 29, 2024

(54) Method and System for Rewarding for Carbon Dioxide Emission Reduction Based on Blockchain

(71) Applicants: Seoul University of Foreign Studies Industry Academy Cooperation Foundation, Seoul (KR); Soonchunhyang Industry Academy Cooperation Foundation, Seoul (KR); Korea Security Evaluation Laboratory Co., Ltd., Seoul (KR)

(72) Inventors: Keundug Park, Seoul (KR); Heungyoul Youm, Seoul (KR)

(73) Assignees: Seoul University of Foreign Studies Industry Academy Cooperation Foundation, Seoul (KR); Soonchunhyang Industry Academy Cooperation Foundation, Seoul (KR); Korea Security Evaluation Laboratory Co., Ltd., Seoul (KR)

(21) Appl. No.: 17/962,851

(22) Filed: Oct. 10, 2022

(30) Foreign Application Priority Data
Aug. 23, 2022 (KR) 10-2022-0105295

(51) Int. Cl. G06Q 30/02

(52) U.S. Cl. CPC G06Q 30/0226; G06Q 30/0225

(57) ABSTRACT

A blockchain-based carbon dioxide emission reduction compensation system is provided that includes a carbon-neutral blockchain system and a Green Coin blockchain system. The carbon-neutral blockchain system receives from an information verifier server at least one of a carbon dioxide emission information message verified by the information verifier server, a carbon dioxide reduction information message verified by the information verifier server, and a carbon neutral cost information message verified by the information verifier server, and transmits a Green Coin reward request to a Green Coin blockchain system. The Green Coin blockchain system transmits a Green Coin reward message to the information verifier server in response to the Green Coin reward request. The availability of the blockchain-based carbon dioxide emission reduction compensation system can be improved and the occurrence of failures can be minimized.

### CROSS-REFERENCE TO RELATED APPLICATION

Pursuant to 35 U.S.C. § 119 (a), this application claims priority benefit to Korean Patent Application No. 10-2022-0105295, filed on Aug. 23, 2022, the content of which is incorporated by reference herein in its entirety.

### BACKGROUND OF INVENTION

### Field of the Invention

The present disclosure relates to methods of rewarding for carbon dioxide emission reduction and systems for rewarding for carbon dioxide emission reduction, and more particularly, to methods and systems for rewarding for carbon dioxide emission reduction based on blockchain.

### Related Art

In order to solve the environmental problems caused by the use of fossil fuels by mankind after the Industrial Revolution, countries around the world, centered on developed countries, agreed to the Kyoto Protocol as a way to specifically implement greenhouse gas reduction goals according to the Climate Change Convention and established a plan to carry out the greenhouse gas reduction project and began to implement it. The greenhouse gases to be reduced are carbon dioxide (CO₂), methane (CH₄), nitrous oxide (N₂O), fluorocarbon (PFC), hydrofluorocarbon (HFC), and sulfur fluoride (SF₆), and carbon dioxide among them is becoming the most important target of reduction.

To prepare a scientific basis for the global warming target of 15° C. agreed in the Paris Agreement, on Oct. 6, 2018, the United Nations Framework Convention on Climate Change (UNFCCC) Intergovernmental Panel on Climate Change (IPCC) reported, “To limit the temperature increase to less than 15° C. by 2100, we need rapid, extensive and unprecedented changes in all sectors of society.” In order to limit the increase in global average temperature to 15° C., carbon dioxide (CO₂) emissions should be reduced by at least 45% by 2030 compared to 2010, and ‘net-zero’ emissions (the state in which anthropogenic carbon dioxide (CO₂) emissions are balanced with anthropogenic absorption) should be achieved by 2050.

Under the current circumstances, it is difficult to expect to achieve the goal of ‘Global Warming 15° C.’ without individuals' voluntary actions to reduce greenhouse gas emissions. To encourage individuals to voluntarily reduce greenhouse gas emissions, there need to be clear and sufficient rewards for doing so.

MOSS of the United States allows exchange of carbon dioxide emission credits in a 1:1 ratio with an Ethereum ERC20 based carbon emission token, and issues carbon emission tokens with the carbon dioxide emission as collateral.

DATAM is conducting a global carbon reduction project which installs sensors in automobiles such as electric motorcycles and electric buses to measure carbon dioxide emissions and compensates for the reduction of carbon dioxide emissions with a cryptocurrency coin called Edel Coin. However, in the case of DATAM's global carbon reduction project, it is difficult to say that it effectively reflects reduction of all the global carbon dioxide emissions, as it is limited to transportation and automobiles account for only about 16% of global carbon dioxide emissions.

Conventionally, in order to reduce or manage carbon dioxide emissions, tokens are issued to trade carbon dioxide emission rights, or carbon dioxide emissions are measured limited to transportation such as automobiles, and the reduction in carbon dioxide emissions was compensated with cryptocurrency coins.

If the measured carbon dioxide emission or carbon dioxide reduction data is intentionally distorted or incorrect data is used, it is difficult to effectively achieve the purpose of reducing carbon dioxide emissions by country and individual around the world.

If there is no verification to secure reliable data on measured carbon dioxide emissions or carbon dioxide reduction data, there is a limit to effectively induce the reduction of carbon dioxide emissions by country and individual around the world.

In addition, conventionally, development is being progressed from the point of view of trading carbon credits through a way that cryptocurrency coins are used for the reward for carbon dioxide reduction and the value of the cryptocurrency used for reward is linked to the price of carbon dioxide credits, but efforts for carbon neutrality, such as the cost of offsetting carbon dioxide emissions, are not fully considered when estimating the value of cryptocurrency used to compensate for carbon dioxide reduction.

### SUMMARY

Embodiments of the present disclosure provides blockchain-based compensation methods of compensating for carbon neutral cost calculated on the basis of verified carbon dioxide emissions data by country and individual around the world with an eco-friendly cryptocurrency coin called Green Coin to promote reduction of carbon dioxide emissions by country and individual around the world.

Embodiments of the present disclosure provides blockchain-based compensation methods of compensating for carbon neutral cost calculated on the basis of verified carbon dioxide emissions data by country and individual around the world with an eco-friendly cryptocurrency coin called Green Coin to promote reduction of carbon dioxide emissions by country and individual around the world.

However, the objects of the present disclosure are not limited thereto, and may be variously expanded without departing from the spirit and scope of the present disclosure.

In accordance with an aspect of the present disclosure, there is provided a blockchain-based carbon dioxide emission reduction compensation system comprising: a carbon-neutral blockchain system that receives from an information verifier server at least one of a carbon dioxide emission information message, verified by the information verifier server, which includes carbon dioxide emissions in at least one period of annual, monthly, weekly, and daily per person by country for calculating a carbon neutral cost for offsetting carbon dioxide, a carbon dioxide reduction information message, verified by the information verifier server, which includes carbon dioxide reduction in at least one period of annual, monthly, weekly and daily by individual, and a carbon neutral cost information message, verified by the information verifier server, which includes a carbon neutral cost in at least one period of annual, monthly, weekly and daily per person by country, and transmits a Green Coin reward request to a Green Coin blockchain system; and the Green Coin blockchain system that provides a Green Coin reward message to the information verifier server in response to the Green Coin reward request.

The carbon neutral cost may be calculated for at least one of a specific year, month, week and day.

The carbon neutral cost information message includes an annual carbon dioxide neutral cost per person which is capable of offsetting cumulative carbon dioxide emissions in the specific year, a monthly carbon dioxide neutral cost per person which is capable of offsetting cumulative carbon dioxide emissions in the specific month, a weekly carbon dioxide neutral cost per person which is capable of offsetting cumulative carbon dioxide emissions in the specific week, and a daily carbon dioxide neutral cost per person which is capable of offsetting cumulative carbon dioxide emissions in the specific day.

The annual carbon neutral cost may be calculated by multiplying the annual carbon dioxide emissions per person per country by a default value of Green Coin, and the default value of the Green Coin may be calculated to correspond to a carbon neutral cost for offsetting a predetermined ton of carbon dioxide at the time of initial issuance.

The carbon neutral cost may be calculated for an increase (+) or a decrease (−) in carbon dioxide emissions compared to at least one of a previous year, month, week, and day.

The carbon neutral cost information message may include a country identifier, an annual carbon dioxide neutral cost per person representing a cost which is capable of offsetting an increase in carbon dioxide emissions compared to the previous year, a monthly carbon dioxide neutral cost per person representing a cost which is capable of offsetting an increase in carbon dioxide emissions compared to the previous month, a weekly carbon dioxide neutral cost per person representing a cost which is capable of offsetting an increase in carbon dioxide emissions compared to the previous week, and a daily carbon dioxide neutral cost per person representing a cost which is capable of offsetting an increase in carbon dioxide emissions compared to the previous day.

The information verifier server may receive the carbon dioxide emissions information message, the carbon dioxide reduction information message, and the carbon neutral cost information message from an information provider server, and verify through inverse calculation whether the annual/monthly/weekly/daily carbon dioxide emissions per person by country, the yearly/monthly/weekly/daily carbon dioxide reduction by individual, the annual/monthly/weekly/daily carbon neutral cost per person by country are calculated correctly.

The Green Coin reward request message may include an identifier of a country to receive a Green Coin reward, an identifier of an individual to receive a Green Coin reward, and a Green Coin reward amount indicating a reward amount to be given to the information provider server and the information verifier server.

The Green Coin blockchain system may provide a Green Coin reward message to at least one of the information provider server and the information verifier server in response to the Green Coin reward request message.

The Green Coin reward message may include a reward date and time, a recipient e-wallet address, and a reward amount.

In accordance with another aspect of the present disclosure, there is provided a blockchain-based carbon dioxide emission reduction compensation method comprising: by a carbon neutral blockchain system, receiving from an information verifier server at least one of carbon dioxide emissions information, verified by the information verifier server, which includes a carbon dioxide emissions in at least one period of annual, monthly, weekly, and daily per person by country for calculating a carbon neutral cost for offsetting carbon dioxide, carbon dioxide reduction information, verified by the information verifier server, which includes carbon dioxide reduction in at least one period of annual, monthly, weekly and daily by individual, and carbon neutral cost information, verified by the information verifier server, which includes a carbon neutral cost in at least one period of annual, monthly, weekly and daily per person by country; transmitting, by the carbon neutral blockchain system, a Green Coin reward request message to a Green Coin blockchain system in response to at least one of the verified carbon dioxide emission information, the verified carbon dioxide reduction information, and the verified carbon neutral cost information; and, providing, by the Green Coin blockchain system, a Green Coin reward message to the information verifier server in response to the Green Coin reward request message.

The blockchain-based carbon dioxide emission reduction compensation method and system according to the above-described embodiments of the present disclosure can improve the availability of the blockchain-based carbon dioxide emission reduction compensation system and minimize the occurrence of failures by separately operating the carbon-neutral blockchain system for managing carbon dioxide emissions and carbon neutral costs per person per country and the Green Coin blockchain system for Green Coin transactions.

In addition, the blockchain-based carbon dioxide emission reduction compensation method and system according to the embodiments of the present disclosure can promote the reduction of carbon dioxide emissions by countries and individuals around the world by verifying all the carbon dioxide emissions data and carbon dioxide reduction data per person per country around the world and calculates carbon neutral cost based on the reliable verified carbon dioxide emissions data and carbon dioxide reduction data and rewarding it with an eco-friendly cryptocurrency coin called Green Coin.

Further, the blockchain-based carbon dioxide emission reduction compensation method and system according to the embodiments of the present disclosure links the value of the Green Coin to carbon neutral costs corresponding to an effort to offset a given amount, e.g., 1 ton, of carbon dioxide without linking it to a price of carbon dioxide emission right, so that it is possible to reward with the Green Coin (e.g., mining, airdrop, etc.) in proportion to the carbon neutral cost corresponding to the effort to offset carbon dioxide by country or by individual.

In addition, the blockchain-based carbon dioxide emission reduction compensation method and system according to the embodiments of the present disclosure can support DeFi service based on reliable data on carbon dioxide emissions and carbon dioxide reductions by country and by individual around the world, which makes it possible to consistently maintain carbon neutral costs.

Furthermore, the blockchain-based carbon dioxide emission reduction compensation method and system according to the embodiments of the present disclosure can collect and analyze precise data on the amount of carbon dioxide emission and absorption by region and by country around the world using satellites, which makes it possible to calculate real-time carbon neutral costs and maintain the carbon neutral costs consistently.

In addition, the blockchain-based carbon dioxide emission reduction compensation method and system according to the embodiments of the present disclosure can promote continuous carbon dioxide reduction by providing Green Coins free of charge (airdrop) to citizens of countries that have reduced carbon dioxide.

Further, the blockchain-based carbon dioxide emission reduction compensation method and system according to the embodiments of the present disclosure can promote carbon dioxide reduction and carbon neutrality by rewarding the participants (information provider server and information verifier server providing carbon dioxide emission information and carbon dioxide reduction information) with a Green Coin.

### BRIEF DESCRIPTION OF THE DRAWINGS

FIG. 1 is a conceptual diagram showing a structure of a blockchain-based carbon dioxide emission reduction compensation system according to one embodiment of the present disclosure.

FIG. 2A is a table showing a message specification for annual/monthly/weekly/daily carbon dioxide emission information per person per country according to one embodiment of the present disclosure.

FIG. 2B is a table showing a message specification for carbon dioxide reduction information (annual/monthly/weekly/daily carbon dioxide reduction by individual) according to one embodiment of the present disclosure.

FIG. 2C is a table showing a message specification for carbon neutral cost information (annual/monthly/weekly/daily carbon neutral cost per person per country) according to one embodiment of the present disclosure.

FIG. 2D is a table showing a Green Coin reward request message specification according to one embodiment of the present disclosure.

FIG. 2E is a table showing a Green Coin reward (mining) message specification according to one embodiment of the present disclosure.

FIG. 2F is a table showing a Green Coin transaction message specification according to one embodiment of the present disclosure.

FIG. 2G is a table showing a free Green Coin reward message specification according to one embodiment of the present disclosure.

FIG. 3 is a table showing an example of calculating the carbon neutral cost per person per country per year in a case where the carbon neutral cost is calculated for a specific year according to one embodiment of the present disclosure.

FIG. 4 is a conceptual diagram illustrating reward and transaction relationships between entities such as a participant, a DeFi service provider, an eco-friendly product seller, an eco-friendly company, and a government agency through a Green Coin blockchain system.

FIG. 5 is a flowchart illustrating a blockchain-based carbon dioxide emission reduction compensation method according to one embodiment of the present disclosure.

### DESCRIPTION OF EXEMPLARY EMBODIMENTS

Various changes may be applied to the present disclosure and the present disclosure may have various embodiments, so a specific embodiment is illustrated in the drawings and will be described in detail.

However, this is not intended to limit the present disclosure to the specific embodiment, and it should be understood to include all modifications, equivalents and substitutes included in the spirit and scope of the present disclosure.

Terms such as first, second, etc. may be used to describe various components, but the components should not be limited by the terms. The above terms are used only for the purpose of distinguishing one component from another. For example, without departing from the scope of the present disclosure, a first component may be referred to as a second component, and similarly, the second component may also be referred to as the first component.

When it is described that a component is “coupled” or “connected” to another component, it may be directly coupled or connected to the other component, but it should be understood that other component may exist therebetween. On the other hand, when it is mentioned that a component is “directly coupled” or “directly connected” to another component, it should be understood that there is no other element therebetween.

The terms used in the present specification are only used to describe a specific embodiment, and are not intended to limit the present disclosure. The singular expression includes the plural expression unless the context clearly indicates otherwise. In the present specification, terms such as “comprise or include” or “have” are intended to designate that a feature, number, step, operation, component, part, or combination thereof described in the specification exists, but it should be understood that this does not exclude the existence or addition of one or more other features, numbers, steps, operations, components, parts, or combinations thereof.

Unless defined otherwise, all terms used herein, including technical and scientific terms, have the same meaning as commonly understood by a person of ordinary skill in the art to which the present disclosure pertains. Terms such as those defined in a commonly used dictionary should be interpreted as having a meaning consistent with the meaning in the context of the related art, and are not interpreted in an ideal or excessively formal meaning unless explicitly defined in the present specification.

Hereinafter, ‘Green Coin’ (GRC) refers to an eco-friendly cryptocurrency for carbon neutral reward through promotion of global carbon dioxide emissions reduction. Specifically, Green Coin represents an eco-friendly cryptocurrency for realizing promotion of carbon dioxide emissions reduction and carbon neutrality and supporting DeFi service linked to carbon dioxide emissions.

Green Coins may be issued as many as the number of people in the world at the time of initial issuance. For example, as of Jun. 22, 2022, the global population is about 7,955,000,000, so if Green Coins would be issued on Jun. 22, 2022, 7,955,000,000 Green Coins can be issued.

New Green Coins may additionally be issued every year as many as the number of global population increased, which results in an increase in the total issuance. Or, existing Green Coins may be discarded as many as the number of global population decreased every year, which results in a reduction in the total issuance.

Green Coin's default value (DV) may be defined as 1 GRC=1 TonCO₂=5 USD ($). The basis for calculating the default value of the Green Coin can be set so that 1 GRC corresponds to the carbon neutral cost to offset 1 ton of carbon dioxide at the time of initial issuance (for example, on Jun. 22, 2022), and 5 USD ($) is an exemplary figure.

Hereinafter, ‘DeFi service’ includes financial services such as payment, settlement agency, remittance, deposit, loan, and investment using blockchain-based cryptocurrency.

Hereinafter, ‘carbon neutral’ means absorbing carbon dioxide as much as carbon dioxide emissions and making the actual emissions of carbon dioxide to ‘0’.

Hereinafter, with reference to the accompanying drawings, embodiments of the present disclosure will be described clearly and in detail so that a person of ordinary skill in the art to which the present disclosure pertains can easily practice the present disclosure.

In the embodiments of the present disclosure, by calculating the carbon neutral cost for each country based on the carbon dioxide emissions for each country, it is possible to induce competition among countries for individual-led reduction of carbon dioxide emissions. Countries with higher carbon dioxide emissions have relatively high carbon neutral costs compared to countries with lower carbon dioxide emissions, and the countries with lower carbon dioxide emissions have relatively more Green Coins than the countries with higher carbon dioxide emissions.

Net CO₂ emission=Total CO₂ emission−Total CO₂ uptake (including CO₂ uptake by plants, e.g. trees)

If the net carbon dioxide emission is 1 ton, the carbon neutral costs may include, for example, social or industrial costs incurred not to emit 1 ton of carbon dioxide in the future. The social cost may include, for example, the cost of constructing a used product transaction service such as Carrot market. Purchasing and using used products through the used product trading service such as Carrot market has the effect of reducing carbon dioxide emissions for producing new products. The industrial cost may include, for example, the cost of upgrading machinery, equipment, and the like.

If the net carbon dioxide emission is 1 ton, for example, the carbon neutral costs may be the cost to offset 1 ton of carbon dioxide already emitted to ‘0’. For example, the cost of planting additional trees to additionally absorb 1 ton of carbon dioxide may correspond to the carbon neutral costs.

The carbon neutral cost may be calculated for a specific year/month/week/day, and may also be calculated for increase (+) or decrease (−) in carbon dioxide emissions for a current year/month/week/day compared to a previous year/month/week/day.

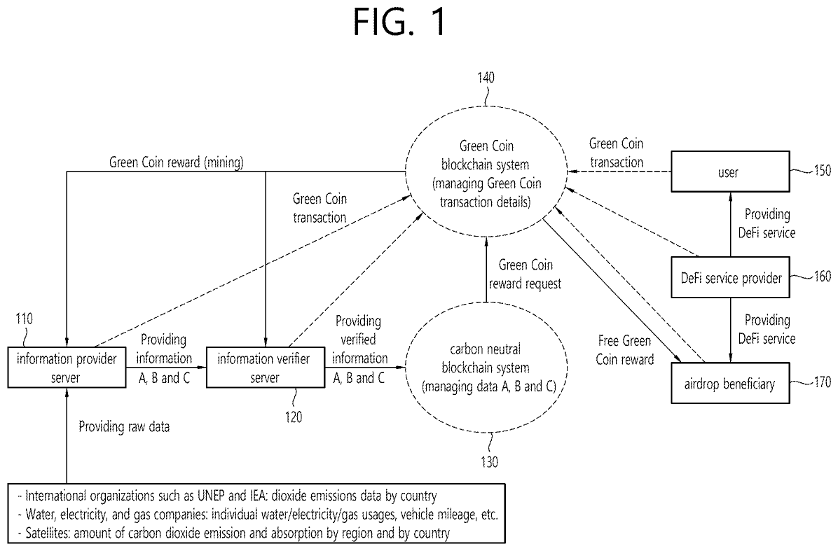

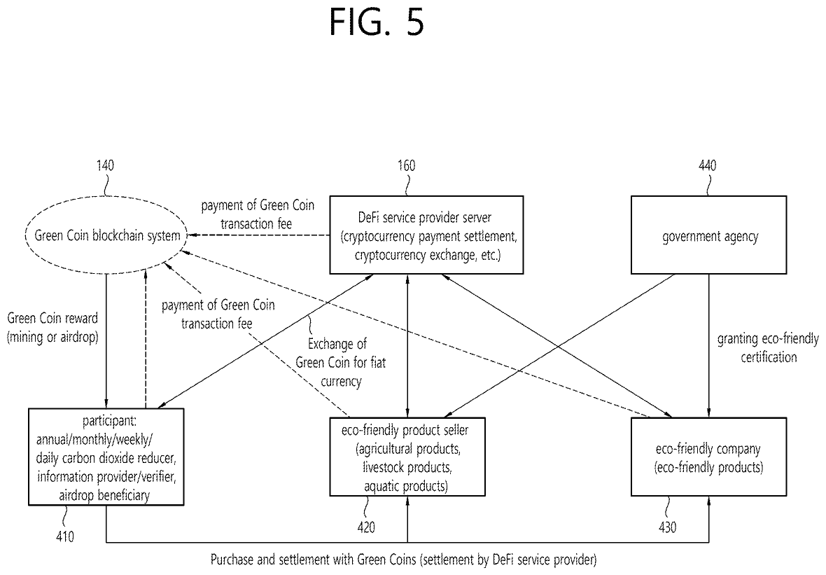

FIG. 1 is a conceptual diagram showing a structure of a blockchain-based carbon dioxide emission reduction compensation system according to one embodiment of the present disclosure. FIG. 5 is a flowchart illustrating a blockchain-based carbon dioxide emission reduction compensation method according to one embodiment of the present disclosure.

Referring to FIG. 1, the blockchain-based carbon dioxide emission reduction compensation system includes a carbon neutral blockchain system 130 and a Green Coin blockchain system 140.

Green Coin transaction data may be stored and retrieved on the blockchain more frequently than carbon dioxide emissions data. In a case where Green Coin transaction data and carbon dioxide emissions data are stored and managed in one blockchain system, if there is a problem in storing and retrieving carbon dioxide emissions data, Green Coin transaction data may not be stored and retrieved. Similarly, if there is a problem in storing and retrieving Green Coin transaction data, carbon dioxide emissions data may not be stored and retrieved. If the Green Coin blockchain system 140 for storing and managing Green Coin transaction data and the carbon neutral blockchain system 130 for storing and managing carbon dioxide emissions data are implemented as separate blockchain systems, the above-described problems (failures) do not occur.

Therefore, the blockchain-based carbon dioxide emission reduction compensation system according to one embodiment of the present disclosure separately operates the carbon-neutral blockchain system 130 for managing carbon dioxide emissions per person and carbon neutral costs by country and the Green Coin blockchain system 140 for Green Coin transactions, which makes it possible to improve the availability of the blockchain-based carbon dioxide emission reduction compensation system and minimize the occurrence of failures.

An information provider server 110 may collect carbon dioxide emissions data by country from international organizations such as the United Nations Environment Program (UNEP), the International Energy Agency (IEA), data on water, electricity, and gas consumption by individual or household from water, electricity, and gas companies, and carbon dioxide emission and absorption data by region and by country from satellites.

That is, the information provider server 110 may collect carbon dioxide emissions data by country, water, electricity, and gas consumption data by individual or household, carbon dioxide emission and absorption data by region and by country as raw data, and may calculate and provide carbon dioxide emission information A, carbon dioxide reduction information B and carbon neutral cost information C to an information verifier server 120.

The information provider server 110 may calculate annual/monthly/weekly/daily carbon dioxide emissions per person per country using carbon dioxide emissions data by country collected from international organizations such as UNEP and IEA, and provide them as carbon dioxide emission information A to the information verifier server 120 (step 501).

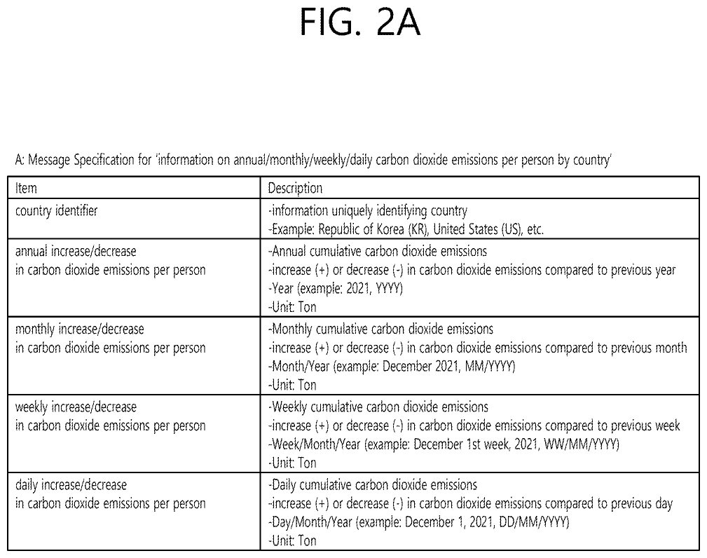

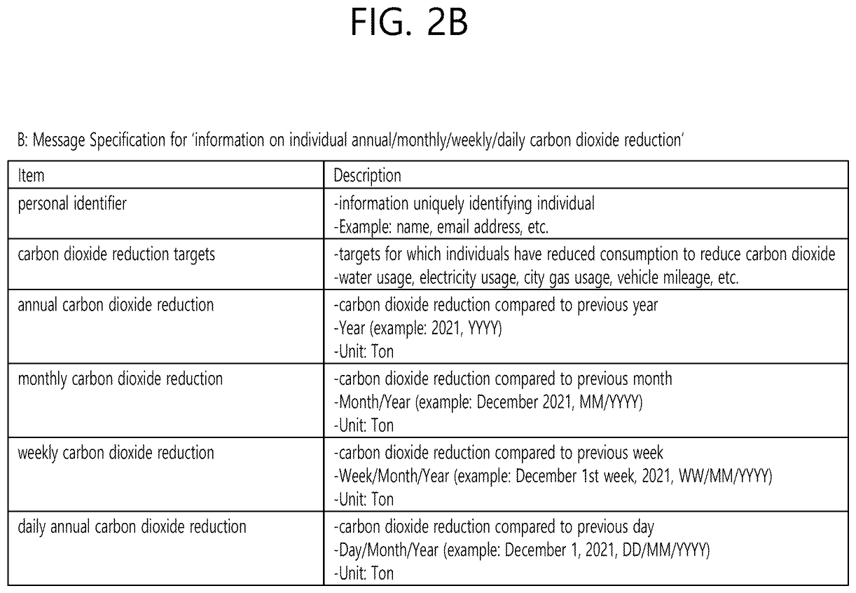

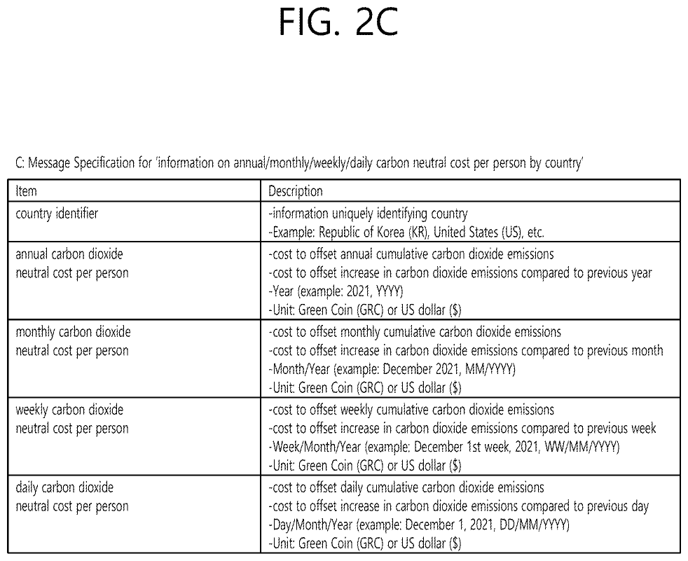

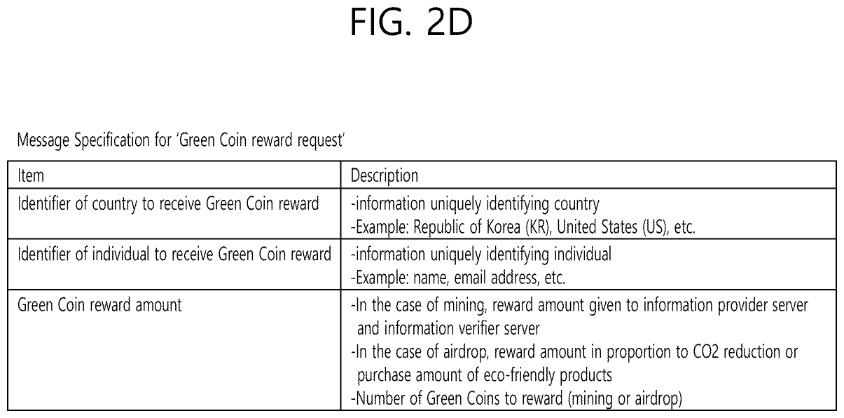

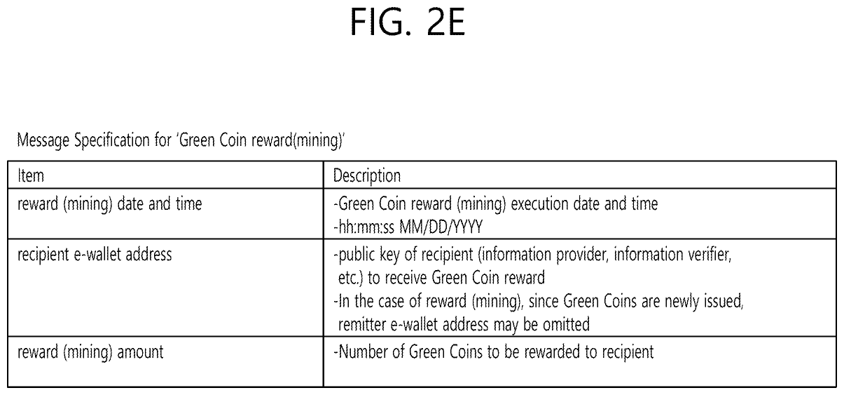

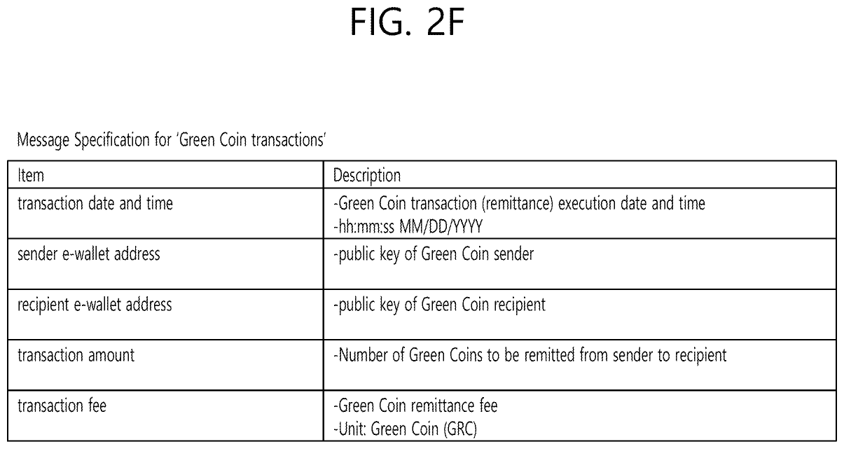

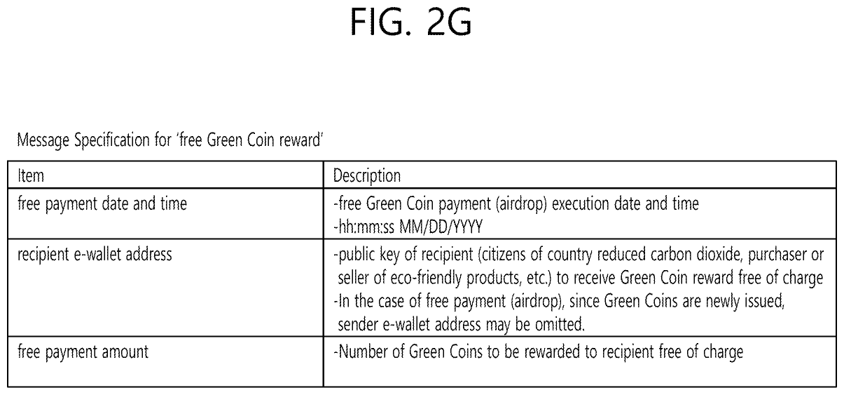

In FIG. 2A, a message specification for the carbon dioxide emission information A (i.e., annual/monthly/weekly/daily carbon dioxide emissions per person by country) provided to the information verifier server 120 is shown in a table. Referring to FIG. 2A, when the carbon neutral cost is calculated for increase (+) or decrease (−) in carbon dioxide emissions compared to a previous year/month/week/day, the message for carbon dioxide emission information A (i.e., annual/monthly/weekly/daily carbon dioxide emissions per person per country) may include a country identifier (information that uniquely identifies a country, for example, Republic of Korea (KR), United States (US), etc.), annual increase/decrease in carbon dioxide emissions per person (increase (+) or decrease (−) in carbon dioxide emissions compared to a previous year), monthly increase/decrease in carbon dioxide emissions per person (increase (+) or decrease (−) in carbon dioxide emissions compared to a previous month), weekly increase/decrease in carbon dioxide emissions per person (increase (+) or decrease (−) in carbon dioxide emissions compared to a previous week), daily increase/decrease in carbon dioxide emissions per person (increase (+) or decrease (−) in carbon dioxide emissions compared to a previous day).

When the carbon neutral cost is calculated for a specific year/month/week/day, the message for carbon dioxide emission information A may further include annual carbon dioxide emissions per person (cumulative carbon dioxide emissions in the specific year), monthly carbon dioxide emissions per person (cumulative carbon dioxide emissions in the specific month), weekly carbon dioxide emissions per person (cumulative carbon dioxide emissions in the specific week), and daily carbon dioxide emissions per person (cumulative carbon dioxide emissions in the specific day).

The information provider server 110 may calculate individual annual/monthly/weekly/daily carbon dioxide reduction (water usage, electricity usage, gas usage, vehicle mileage, etc.) using individual or household water, electricity, and gas usage data collected from water, electricity, and gas companies and provide them to the information verifier server 120 as carbon dioxide reduction information B.

In FIG. 2B, a message specification for the carbon dioxide reduction information B (i.e., individual annual/monthly/weekly/daily carbon dioxide reduction) provided to the information verifier server 120 is shown in a table.

Referring to FIG. 2B, the message for the carbon dioxide reduction information B (i.e., individual annual/monthly/weekly/daily carbon dioxide reduction) may include personal identifier (information that uniquely identifies an individual, for example, name, email address, etc.), carbon dioxide reduction target(s) (targets for which individuals have reduced their consumption to reduce carbon dioxide, for example, water usage, electricity usage, city gas usage, vehicle mileage, etc.), annual carbon dioxide reduction (carbon dioxide reduction compared to a previous year), monthly carbon dioxide reduction (carbon dioxide reduction compared to a previous month), weekly carbon dioxide reduction (carbon dioxide reduction compared to a previous week), daily carbon dioxide reduction (carbon dioxide reduction compared to a previous day). The unit of the carbon dioxide reduction may be a ton (Ton).

The information provider server 110 may calculate the annual/monthly/weekly/daily carbon neutral cost per person by country using carbon dioxide emission and absorption data by region and by country collected from satellites, and provide them to the information verifier server (120) as carbon neutral cost information C. Here, the amount of carbon dioxide absorption may be used to calculate carbon neutral costs. For example, if 100 tons of carbon dioxide is emitted and 80 tons of carbon dioxide is absorbed, a cost to offset 20 tons of carbon dioxide obtained by subtracting the carbon dioxide absorption from the carbon dioxide emissions may be calculated as a carbon dioxide neutral cost.

In FIG. 2C, a message specification for the carbon neutral cost information C (i.e., annual/monthly/weekly/daily carbon neutral cost per person by country) provided to the information verifier server 120 is shown in a table.

Referring to FIG. 2C, when carbon neutral cost is calculated for increase (+) or decrease (−) of carbon dioxide emissions in a current year/month/week/day compared to a previous year/month/week/day, the message for the carbon neutral cost information C (i.e., annual/monthly/weekly/daily carbon neutral cost per person by country) may include a country identifier (information that uniquely identifies a country, for example, Republic of Korea (KR), United States (US), etc.), annual carbon dioxide neutral cost per person (cost to offset the increase in carbon dioxide emissions compared to the previous year), monthly carbon dioxide neutral cost per person (cost to offset the increase in carbon dioxide emissions compared to the previous month), weekly carbon dioxide neutral cost per person (cost to offset the increase in carbon dioxide emissions compared to the previous week), and daily carbon dioxide neutral cost per person (cost to offset the increase in carbon dioxide emissions compared to the previous day). Here, the unit of carbon dioxide neutral cost may be Green Coin (GRC) or US dollar (If carbon dioxide emissions are reduced compared to the previous year/month/week/day, the carbon dioxide neutral cost is zero (0).

When the carbon neutral costs are calculated for a specific year/month/week/day, the message for the carbon neutral cost information C (i.e. annual/monthly/weekly/daily carbon neutral costs per person by country) may include annual carbon dioxide neutral cost per person (costs to offset the cumulative carbon dioxide emissions for the specific year), monthly carbon dioxide neutral cost per person (costs to offset the cumulative carbon dioxide emissions for the specific year), weekly carbon dioxide neutral cost per person (costs to offset the cumulative carbon dioxide emissions for the specific year), and daily carbon dioxide neutral cost per person (costs to offset the cumulative carbon dioxide emissions for the specific year).

The annual carbon neutral cost (AC) may be calculated by multiplying the annual carbon dioxide emissions (unit: ton) per person by country by the above-mentioned Green Coin default value (DV, 5 USD).

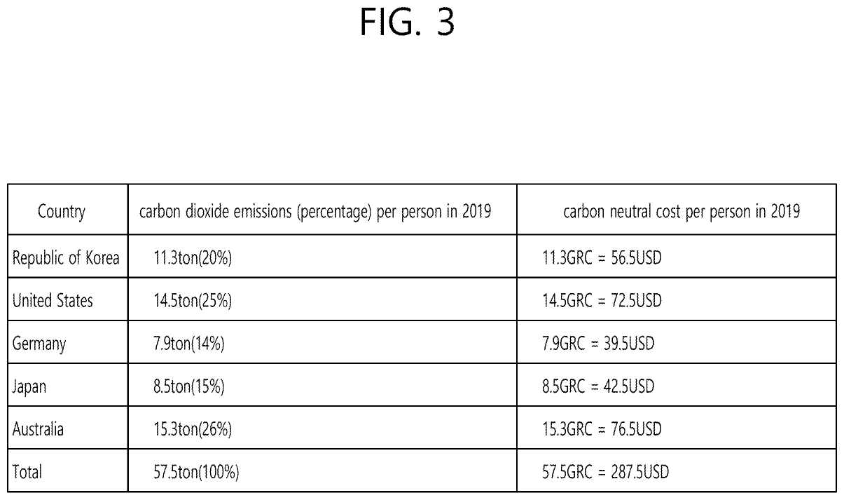

FIG. 3 shows an example of calculating the carbon neutral cost per person by country in a specific year in a table when the carbon neutral cost is calculated for the specific year.

Referring to FIG. 3, the carbon neutral cost per person by country in a specific year is calculated based on the carbon dioxide emissions per person for the country in the specific year, and the more carbon dioxide is emitted, the higher the carbon neutral cost. Referring to FIG. 3, in the case of Republic of Korea, the carbon neutral cost per person for the country in 2019 may be calculated by multiplying 11.3 tons of carbon dioxide emissions per person in Republic of Korea in 2019 by 5 USD.

When the carbon neutral cost is calculated for a specific month, the monthly carbon neutral cost (MC) may be calculated by multiplying the monthly carbon dioxide emission (ton) per person by country by the above-mentioned Green Coin default value (DV, 5 USD).

When the carbon neutral cost is calculated for a specific week, the weekly carbon neutral cost (WC) may be calculated by multiplying the weekly carbon dioxide emissions (ton) per person by country by the above-mentioned Green Coin default value (DV, 5 USD).

When the carbon neutral cost is calculated for a specific day, the daily carbon neutral cost (DC) may be calculated by multiplying the daily carbon dioxide emissions (ton) per person by country by the above-mentioned Green Coin default value (DV, 5 USD).

The information verifier server 120 receives the carbon dioxide emission information A, the carbon dioxide reduction information B, and the carbon neutral cost information C from the information provider server 110 and verifies through inverse calculation whether the annual/monthly/weekly/daily carbon dioxide emissions per person by country, the annual/monthly/weekly/daily carbon dioxide reduction (water, electricity, and gas consumption, vehicle mileage, etc.) per person by country, and the annual/monthly/weekly/daily carbon neutral cost per person by country have been correctly calculated. In addition, if necessary, it can be verified through recalculation using the raw data of FIG. 1.

The information verifier server 120 provides the verified carbon dioxide emission information A, the verified carbon dioxide reduction information B, and the verified carbon neutral cost information C to the carbon neutral blockchain system 130 (step 505).

The carbon neutral blockchain system 130 stores the verified carbon dioxide emission information A, the verified carbon dioxide reduction information B, and the verified carbon neutral cost information C in each node in blockchain (step 507) and manages them in the blockchain.

The carbon-neutral blockchain system 130 confirms the verified carbon dioxide emission information A, the verified carbon dioxide reduction information B, and the verified carbon neutral cost information C, and transmits a Green Coin reward request message to the Green Coin blockchain system 140.

Referring to the table of FIG. 2D, the Green Coin reward request message may include an identifier of a country to receive the Green Coin reward (for example, information that uniquely identifies a country such as Republic of Korea (KR), the United States (US), etc.), an identifier of an individual to be rewarded with Green Coins (for example, information that uniquely identifies an individual, such as name and email address), and an amount of reward given to the information provider server 110 and the information verifier server 120 in the case of mining. The Green Coin reward request message of FIG. 2D may further include information indicating a target to which the Green Coin reward is to be given (for example, the information provider server 110 and the information verifier server 120.

In response to the Green Coin reward request message, the Green Coin blockchain system 140 provides a Green Coin reward (mining) message to the information provider server 110 (step 511), and provides the Green Coin reward (mining) message to the information verifier server 120 (step 513).

Referring to FIG. 2E, the Green Coin reward (mining) message may include reward (mining) date and time (for example, Green Coin reward (mining) execution date and time), recipient e-wallet address (for example, a public key of a recipient (the information provider server 110, the information verifier server 120, etc.)), and an amount of reward (mining) (the amount of Green Coins to be rewarded to the recipient). Here, in the case of reward (mining), since Green Coins are newly issued, a remitter e-wallet address may be omitted.

After the Green Coin reward (mining) is made, the information provider server 110 provides a Green Coin transaction message to the Green Coin blockchain system 140 to give a Green Coin transaction fee to the Green Coin blockchain system 140 (step 521).

Hereinafter, the Green Coin transaction refers to exchange of Green Coins between owners of Green Coin electronic wallets, and means, for example, transfer of Green Coins from an electronic wallet of a Green Coin sender to an electronic wallet of a Green Coin recipient.

When a Green Coin transaction occurs between a Green Coin sender (for example, a user 150 and an airdrop beneficiary 170 in FIG. 1) and a Green Coin recipient (for example, DeFi service provider 160 in FIG. 1), a Green Coin transaction fee is paid from the Green Coin sender's electronic wallet to the Green Coin blockchain system 140. Here, the Green Coin transaction fee is a kind of blockchain usage fee or Green Coin remittance fee, and 0.5% of the Green Coin transaction amount (or transaction amount) (for example, 500 Green Coins when trading 100,000 Green Coins) may be charged.

After the Green Coin reward (mining) is made, the information verifier server 120 provides a Green Coin transaction message to the Green Coin blockchain system 140 to give a Green Coin transaction fee to the Green Coin blockchain system 140 (step 525).

Referring to FIG. 2F, the Green Coin transaction message may include transaction date and time (for example, Green Coin transaction (remittance) execution date and time), sender e-wallet address (for example, a public key of a Green Coin sender), recipient e-wallet address (for example, a public key of a Green Coin recipient), transaction amount (the number of Green Coins to be remitted from the sender to the recipient), and transaction fee (Green Coin remittance fee in unit of Green Coin (GRC)).

The Green Coin blockchain system 140 records the Green Coin mining or transaction records in a distributed ledger of the Green Coin blockchain system. The transaction details of Green Coins recorded in the distributed ledger may include date and time of transaction (execution date and time of Green Coin transaction (remittance)), a sender e-wallet address (e.g., a public key of a Green Coin sender), a recipient e-wallet address (e.g., a public key of a Green Coin recipient), transaction amount (amount of Green Coins to be transferred from the sender to the recipient), and transaction fee (Green Coin remittance fee in unit of Green Coin (GRC)).

The Green Coin blockchain system 140 may give a Green Coin reward (airdrop) to purchasers of eco-friendly products and citizens of countries that have reduced carbon dioxide (step 515).

The Green Coin blockchain system 140 may give a Green Coin reward (airdrop) to eco-friendly product sellers (step 517).

Referring to the table in FIG. 2G, a free Green Coin reward message may include free payment date and time (free Green Coin payment (airdrop) execution date and time), a recipient e-wallet address (a public key of a recipient (citizens of a country that has reduced carbon dioxide, a purchaser or seller of eco-friendly products, etc.), and free payment amount (amount of Green Coins to be given free of charge to the recipient). Here, in the case of free payment (airdrop), since Green Coins are newly issued, a sender e-wallet address may be omitted.

The eco-friendly product seller 420, the eco-friendly product purchaser, and the airdrop beneficiary 170 can transfer and sell the rewarded Green Coin to the DeFi service provider 160 to exchange it for fiat currency.

The airdrop beneficiary 170 purchases an eco-friendly product from the eco-friendly product seller 420, receives a Green Coin reward (airdrop) from the Green Coin blockchain system 140, and remits the rewarded Green Coin to the DeFi service provider 160 to exchange it for fiat currency. The airdrop beneficiary 170 pays a Green Coin transfer fee to the Green Coin blockchain system 140 when a transaction of transferring the rewarded Green Coin to the DeFi service provider 160 occurs (step 523d).

The eco-friendly product seller 420 pays a Green Coin transfer fee to the Green Coin blockchain system 140 when a transaction of transferring the rewarded Green Coin to the DeFi service provider 160 occurs (step 523c).

The user 150 may purchase Green Coins from the DeFi service provider 160 (e.g., a cryptocurrency exchange) or exchange the purchased Green Coins for fiat currency and sell them for cash. When such a Green Coin transaction occurs, the user 150 pays a Green Coin transfer fee to the Green Coin blockchain system 140 (step 523a).

The DeFi service provider 160 pays a Green Coin transfer fee to the Green Coin blockchain system 140 when the Green Coin transaction as described above occurs (step 523b).

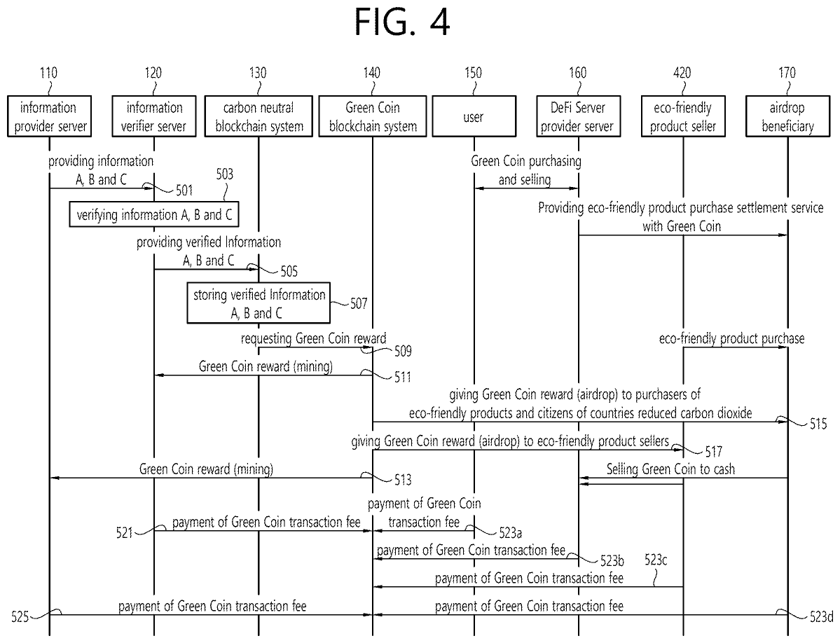

FIG. 4 shows reward and transaction relationships between entities such as a participant 410, a DeFi service provider 160, an eco-friendly product seller 420, an eco-friendly company 430, and a government agency 440 through the Green Coin blockchain system 140.

The participant 410 may include an annual/monthly/weekly/daily carbon dioxide reducer, the information provider server 110, the information verifier server 120, an airdrop beneficiary 170, and the like.

The DeFi service provider 160 may provide financial services such as exchange of cryptocurrency (Green Coin) for fiat currency, cryptocurrency payment settlement, and loan based on blockchain to the participant 410, the eco-friendly product seller 420, and the eco-friendly company 430.

The eco-friendly product seller 420 is an entity that sells eco-friendly products such as agricultural products, livestock products, and aquatic products like a farmer. The eco-friendly company 430 is an entity that produces eco-friendly products.

The government agency 440 may grant an eco-friendly certification to the eco-friendly product seller 420 and the eco-friendly company 430.

The Green Coin blockchain system 140 provides a Green Coin reward (mining or airdrop) to the participant 410.

The participant 410, the DeFi service provider 160, the eco-friendly product seller 420, and the eco-friendly company 430 pay a Green Coin transfer fee to the Green Coin blockchain system 140.

The blockchain-based carbon dioxide emission reduction compensation method and system according to the embodiments of the present disclosure can promote continuous carbon dioxide reduction by providing Green Coins free of charge (airdrop) to citizens of countries that have reduced carbon dioxide.

The number of Green Coins obtained by dividing 100 Green Coins by the population of a country that has reduced 1 ton of carbon dioxide per month can be provided free of charge (airdrop) to individual electronic wallets (the balance of Green Coins must be at least 0.1). For example, if 100 tons of carbon dioxide has been reduced in Republic of Korea, 0.0002 Green Coins, obtained by dividing (100 tons×100 Green Coins) by 50 million people, can be paid to each individual electronic wallet. If the number of electronic wallets is larger than the population, it may be divided by the number of electronic wallets.

The blockchain-based carbon dioxide emission reduction compensation method and system according to the embodiments of the present disclosure can promote carbon dioxide reduction and carbon neutrality by rewarding participants (the information provider server and the information verifier server that provide information on carbon dioxide emissions and carbon dioxide reduction). If 1 ton of carbon dioxide is reduced, 100 Green Coins can be rewarded (mined). The amount of Green Coin mined may be reduced by 10% every two years. 200,000 Green Coins may be rewarded (mined) when the participants provide carbon dioxide emissions and carbon dioxide reduction data by country for one year to the carbon-neutral blockchain system 130.

The operations of the blockchain-based carbon dioxide emission reduction compensation method according to the embodiments of the present disclosure described above may be implemented as computer-readable codes on a computer-readable recording medium. The computer-readable recording medium includes all types of recording mediums in which data that can be read by a computer system are stored. For example, the computer-readable recording medium may include a read only memory (ROM), a random access memory (RAM), a magnetic tape, a magnetic disk, a flash memory, an optical data storage device, and the like. In addition, the computer-readable recording medium may be distributed in computer systems connected through a computer communication network, and stored and executed as codes that can be read in a distributed manner.

Although described above with reference to the drawings and the embodiments, it does not mean that the scope of protection of the present disclosure is limited by the drawings or the embodiments, and those skilled in the art will understood that various modifications and changes of the present disclosure can be made without departing from the spirit and scope of the present disclosure described in the following claims.

What is claimed is:

1. A blockchain-based carbon dioxide emission reduction compensation system comprising:
a carbon-neutral blockchain system that receives from an information verifier server at least one of a carbon dioxide emission information message verified by the information verifier server, a carbon dioxide reduction information message verified by the information verifier server, and a carbon neutral cost information message verified by the information verifier server, and transmits a Green Coin reward request to a Green Coin blockchain system, wherein the carbon dioxide emission information includes carbon dioxide emissions in at least one period of annual, monthly, weekly, and daily per person by country for calculating a carbon neutral cost for offsetting carbon dioxide, wherein the carbon dioxide reduction information includes a carbon dioxide reduction in at least one period of annual, monthly, weekly and daily by individual, and wherein the carbon neutral cost information includes a carbon neutral cost in at least one period of annual, monthly, weekly and daily per person by country; and wherein the Green Coin blockchain system transmits a Green Coin reward message to the information verifier server in response to the Green Coin reward request.

2. The blockchain-based carbon dioxide emission reduction compensation system of claim 1, wherein the carbon neutral cost is calculated for at least one of a specific year, month, week and day.

3. The blockchain-based carbon dioxide emission reduction compensation system of claim 2, wherein the carbon neutral cost information message includes an annual carbon dioxide neutral cost per person which offsets cumulative carbon dioxide emissions in the specific year, a monthly carbon dioxide neutral cost per person which is capable of offsetting cumulative carbon dioxide emissions in the specific month, a weekly carbon dioxide neutral cost per person which is capable of offsetting cumulative carbon dioxide emissions in the specific week, and a daily carbon dioxide neutral cost per person which is capable of offsetting cumulative carbon dioxide emissions in the specific day.

4. The blockchain-based carbon dioxide emission reduction compensation system of claim 1, wherein the annual carbon neutral cost is calculated by multiplying the annual carbon dioxide emissions per person by country by a default value of Green Coin, and the default value of the Green Coin is calculated to correspond to a carbon neutral cost for offsetting a predetermined ton of carbon dioxide at the time of initial issuance.

5. The blockchain-based carbon dioxide emission reduction compensation system of claim 1, wherein the carbon neutral cost is calculated for an increase (+) or a decrease (−) in carbon dioxide emissions compared to at least one of a previous year, month, week, and day.

6. The blockchain-based carbon dioxide emission reduction compensation system of claim 5, wherein the carbon neutral cost information message includes a country identifier, an annual carbon dioxide neutral cost per person representing a cost to offset an increase in carbon dioxide emissions compared to the previous year, a monthly carbon dioxide neutral cost per person representing a cost to offset an increase in carbon dioxide emissions compared to the previous month, a weekly carbon dioxide neutral cost per person representing a cost to offset an increase in carbon dioxide emissions compared to the previous week, and a daily carbon dioxide neutral cost per person representing a cost to offset an increase in carbon dioxide emissions compared to the previous day.

7. The blockchain-based carbon dioxide emission reduction compensation system of claim 1, wherein the information verifier server receives the carbon dioxide emissions information message, the carbon dioxide reduction information message, and the carbon neutral cost information message from the information provider server, and verifies through inverse calculation whether the annual/monthly/weekly/daily carbon dioxide emissions per person by country, the yearly/monthly/weekly/daily carbon dioxide reduction by individual, the annual/monthly/weekly/daily carbon neutral cost per person by country are calculated correctly.

8. The blockchain-based carbon dioxide emission reduction compensation system of claim 1, wherein the Green Coin reward request message includes an identifier of a country to receive a Green Coin reward, an identifier of an individual to receive a Green Coin reward, and a Green Coin reward amount indicating a reward amount to be given to the information provider server and the information verifier server.

9. The blockchain-based carbon dioxide emission reduction compensation system of claim 1, wherein the Green Coin blockchain system provides a Green Coin reward message to at least one of the information provider server and the information verifier server in response to the Green Coin reward request message.

10. The blockchain-based carbon dioxide emission reduction compensation system of claim 9, wherein the Green Coin reward message includes a reward date and time, a recipient e-wallet address, and a reward amount.

11. A blockchain-based carbon dioxide emission reduction compensation method comprising:
receiving, by a carbon neutral blockchain system, from an information verifier server at least one of carbon dioxide emissions information, verified by the information verifier server, which includes carbon dioxide emissions in at least one period of annual, monthly, weekly, and daily per person by country for calculating a carbon neutral cost for offsetting carbon dioxide, carbon dioxide reduction information, verified by the information verifier server, which includes a carbon dioxide reduction in at least one period of annual, monthly, weekly and daily by individual, and carbon neutral cost information, verified by the information verifier server, which includes a carbon neutral cost in at least one period of annual, monthly, weekly and daily per person by country;
transmitting, by the carbon neutral blockchain system, a Green Coin reward request message to a Green Coin blockchain system in response to at least one of the verified carbon dioxide emission information, the verified carbon dioxide reduction information, and the verified carbon neutral cost information; and
providing, by the Green Coin blockchain system, a Green Coin reward message to the information verifier server in response to the Green Coin reward request message.

12. The blockchain-based carbon dioxide emission reduction compensation method of claim 11, wherein the carbon neutral cost is calculated for at least one of a specific year, month, week and day.

13. The blockchain-based carbon dioxide emission reduction compensation method of claim 12, wherein the carbon neutral cost information includes an annual carbon dioxide neutral cost per person which offsets cumulative carbon dioxide emissions in the specific year, a monthly carbon dioxide neutral cost per person which is capable of offsetting cumulative carbon dioxide emissions in the specific month, a weekly carbon dioxide neutral cost per person which is capable of offsetting cumulative carbon dioxide emissions in the specific week, and a daily carbon dioxide neutral cost per person which is capable of offsetting cumulative carbon dioxide emissions in the specific day.

14. The blockchain-based carbon dioxide emission reduction compensation method of claim 11, wherein the annual carbon neutral cost is calculated by multiplying the annual carbon dioxide emissions per person by country by a default value of Green Coin, and the default value of the Green Coin is calculated to correspond to a carbon neutral cost for offsetting a predetermined ton of carbon dioxide at the time of initial issuance.

15. The blockchain-based carbon dioxide emission reduction compensation method of claim 11, wherein the carbon neutral cost is calculated for an increase (+) or a decrease (−) in carbon dioxide emissions compared to at least one of a previous year, month, week, and day.

16. The blockchain-based carbon dioxide emission reduction compensation method of claim 15, wherein the carbon neutral cost information includes a country identifier, an annual carbon dioxide neutral cost per person representing a cost to offset an increase in carbon dioxide emissions compared to the previous year, a monthly carbon dioxide neutral cost per person representing a cost to offset an increase in carbon dioxide emissions compared to the previous month, a weekly carbon dioxide neutral cost per person representing a cost to offset an increase in carbon dioxide emissions compared to the previous week, and a daily carbon dioxide neutral cost per person representing a cost to offset an increase in carbon dioxide emissions compared to the previous day.

17. The blockchain-based carbon dioxide emission reduction compensation method of claim 11, wherein the information verifier server receives the carbon dioxide emissions information, the carbon dioxide reduction information, and the carbon neutral cost information from the information provider server, and verifies through inverse calculation whether the annual/monthly/weekly/daily carbon dioxide emissions per person by country, the yearly/monthly/weekly/daily carbon dioxide reduction by individual, the annual/monthly/weekly/daily carbon neutral cost per person by country are calculated correctly.

18. The blockchain-based carbon dioxide emission reduction compensation method of claim 11, wherein the Green Coin reward request message includes an identifier of a country to receive a Green Coin reward, an identifier of an individual to receive a Green Coin reward, and a Green Coin reward amount indicating a reward amount to be given to the information provider server and the information verifier server.

19. The blockchain-based carbon dioxide emission reduction compensation method of claim 11, wherein the Green Coin blockchain system provides a Green Coin reward message to at least one of the information provider server and the information verifier server in response to the Green Coin reward request message.

20. The blockchain-based carbon dioxide emission reduction compensation method of claim 19, wherein the Green Coin reward message includes a reward date and time, a recipient e-wallet address, and a reward amount.
